(19) United States
(12) Patent Application Publication
(10) Pub. No.: US 2006/0165303 A1
(43) Pub. Date: Jul. 27, 2006

(54) Video coding method and apparatus for efficiently predicting unsynchronized frame

(75) Inventors: Sang-chang Cha, Hwaseong-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/336,953

(22) Filed: Jan. 23, 2006

Related U.S. Application Data
(60) Provisional application No. 60/645,009, filed on Jan. 21, 2005.

(30) Foreign Application Priority Data
Mar. 12, 2005 (KR) 10-2005-0020810

(51) Int. Cl. G06K 9/46

(52) U.S. Cl. 382/240

(57) ABSTRACT

A multi-layered video encoding method is provided wherein motion estimation is performed by using one of two frames of a lower layer temporally closest to an unsynchronized frame of a current layer as a reference frame. A virtual base layer frame at the same temporal location as that of the unsynchronized frame is generated using a motion vector obtained as a result of the motion estimation and the reference frame. The generated virtual base layer frame is subtracted from the unsynchronized frame to generate a difference, and the difference is encoded.

### CROSS-REFERENCE TO RELATED APPLICATIONS

This application claims priority from Korean Patent Application No. 10-2005-0020810 filed on Mar. 12, 2005 in the Korean Intellectual Property Office, and U.S. provisional patent application Ser. No. 60/645,009 filed on Jan. 21, 2005 in the United States Patent and Trademark Office, the disclosures of which are incorporated herein by reference in their entirety.

### BACKGROUND OF THE INVENTION

1. Field of the Invention

Methods and apparatuses consistent with the present invention relate, in general, to video compression and, more particularly, to efficiently predicting a frame having no corresponding lower layer frame in video frames having a multi-layered structure.

2. Description of the Related Art

With the development of information and communication technology using the Internet, video communication has increased along with text and voice communication. Conventional text-based communication methods are insufficient to satisfy consumer requirements, and therefore multimedia services capable of accommodating various types of information, such as text, images and music, have increased. Multimedia data has a large size, and thus it requires high capacity storage media, and a wide bandwidth for transmission. Therefore, in order to transmit multimedia data including text, images and audio, it is essential to use compression and coding techniques.

The basic principle of compressing data involves a process of removing data redundancy. Spatial redundancy, in which the same color or object is repeated in an image, temporal redundancy, in which an adjacent frame varies little in moving image frames or in which the same sound is repeated in audio data, and psycho-visual redundancy, which takes into consideration the fact that human vision and perceptivity are insensitive to high frequencies, are removed so that data can be compressed. In a typical video coding method, temporal redundancy is removed using temporal filtering based on motion compensation, and spatial redundancy is removed using a spatial transform.

In order to transmit generated multimedia data, transmission media are required. The performances of the transmission media differ. Currently used transmission media have various data rates ranging from a data rate like that of an ultra high speed communication network, capable of transmitting data at a data rate of several tens of Mbit/s, to a data rate like that of a mobile communication network, having a data rate of 384 Kbit/s. In this environment, a method of transmitting multimedia data at a data rate suitable for supporting transmission media having various data rates or depending on transmission different environments, that is, a scalable video coding method, may be more suitable for a multimedia environment.

Such scalable video coding denotes an encoding method of cutting part of a previously compressed bit stream depending on surrounding conditions, such as bit rate, error rate or system resources, thus controlling the resolution, the frame rate and the bit rate of the video. Moving Picture Experts Group-21 (MPEG-21) part 10 is the current standard for scalable video coding. In the standardization of scalable video coding, many efforts have been made to realize multi-layered scalability. For example, multiple layers, including a base layer, a first enhancement layer, and a second enhancement layer, are provided, so that respective layers can be constructed to have different frame rates or different resolutions, such as the Quarter Common Intermediate Format (QCIF), CIF and 2CIF.

FIG. 1 is a diagram showing an example of a scalable video codec using a multi-layered structure. First, a first layer is in the Quarter Common Intermediate Format (QCIF) and has a frame rate of 15 Hz, a first enhancement layer is in the Common Intermediate Format (CIF) and has a frame rate of 30 Hz, and a second enhancement layer is in the Standard Definition (SD) and has a frame rate of 60 Hz. If a CIF 0.5 Mbps stream is required, a bit stream needs to be truncated and transmitted so that a bit rate is 0.5 Mbps in the first enhancement layer with a CIF, a frame rate 30 Hz and a bit rate of 0.7 Mbps. Using this method, spatial, temporal and SNR scalabilities can be realized.

As shown in FIG. 1, frames in respective layers having the same temporal location (for example, 10, 20, and 30) can be assumed to have similar images. Therefore, a method of predicting the texture of a current layer from the texture of a lower layer (directly, or after the texture of the lower layer has been upsampled), and encoding the difference between the predicted value and the actual texture of the current layer is generally known. “Scalable Video Model 3.0 of ISO/IEC 21000-13 Scalable Video Coding” (hereinafter referred to as “SVM 3.0”) defines the above method as Intra-BL prediction.

In this way, SVM 3.0 additionally adopts a method of predicting a current block using the correlation between a current block and a corresponding lower layer block, in addition to inter-prediction and directional intra-prediction, which are used to predict blocks or macroblocks constituting a current frame in the existing H.264 method. Such a prediction method is called “Intra-BL prediction”, and a mode of performing encoding using the Intra-BL prediction is called “Intra-BL mode”.

FIG. 2 is a schematic diagram showing the three prediction methods, which shows a case \textcircled{1} where intra-prediction is performed with respect to a certain macroblock 14 of a current frame 11, a case \textcircled{2} where inter-prediction is performed using a frame 12 placed at a temporal location differing from that of the current frame 11, and a case \textcircled{3} where Intra-BL prediction is performed using the texture data of an area 16 of a base layer frame 13 corresponding to the macroblock 14.

As described above, in the scalable video coding standards, an advantageous method is selected from among the three prediction methods.

However, if frame rates between layers are different, as shown in FIG. 1, a frame 40 having no corresponding lower layer frame may exist. With respect to the frame 40, Intra-BL prediction cannot be used. Accordingly, in this case, the frame 40 is encoded using only information about a corresponding layer (that is, using inter-prediction and intra-prediction) without using information about a lower layer, so that the prediction methods may be somewhat inefficient from the standpoint of encoding performance.

### SUMMARY OF THE INVENTION

The present invention provides a video coding method, which can perform Intra-BL prediction with respect to an unsynchronized frame.

The present invention also provides a scheme, which can improve the performance of a multi-layered video codec using the video coding method.

In accordance with one aspect of the present invention, there is provided a multi-layered video encoding method comprising performing motion estimation by using one of two frames of a lower layer temporally closest to an unsynchronized frame of a current layer as a reference frame; generating a virtual base layer frame at the same temporal location as that of the unsynchronized frame using a motion vector obtained as a result of the motion estimation and the reference frame; subtracting the generated virtual base layer frame from the unsynchronized frame to generate a difference; and encoding the difference.

In accordance with another aspect of the present invention, there is provided a multi-layered video decoding method comprising the steps of reconstructing a reference frame of two frames of a lower layer, temporally closest to an unsynchronized frame of a current layer, from a lower layer bit stream; generating a virtual base layer frame at the same temporal location as the unsynchronized frame using a motion vector, included in the lower layer bit stream, and the reconstructed reference frame; extracting texture data of the unsynchronized frame from a current layer bit stream, and reconstructing a residual frame from the texture data; and adding the residual frame to the virtual base layer frame.

In accordance with a further aspect of the present invention, there is provided a multi-layered video encoder comprising means for performing motion estimation by using one of two frames of a lower layer temporally closest to an unsynchronized frame of a current layer as a reference frame; means for generating a virtual base layer frame at the same temporal location as that of the unsynchronized frame using a motion vector obtained as a result of the motion estimation and the reference frame; means for subtracting the generated virtual base layer frame from the unsynchronized frame to generate a difference; and means for encoding the difference.

In accordance with yet another aspect of the present invention, there is provided a multi-layered video decoder comprising means for reconstructing a reference frame of two frames of a lower layer, temporally closest to an unsynchronized frame of a current layer, from a lower layer bit stream; means for generating a virtual base layer frame at the same temporal location as the unsynchronized frame using a motion vector, included in the lower layer bit stream, and the reconstructed reference frame; means for extracting texture data of the unsynchronized frame from a current layer bit stream, and reconstructing a residual frame from the texture data; and means for adding the residual frame to the virtual base layer frame.

### BRIEF DESCRIPTION OF THE DRAWINGS

The above and/or other aspects of the present invention will be more apparent by describing exemplary embodiments of the present invention with reference to the accompanying drawings, in which:

FIG. 1 is a diagram showing an example of a scalable video codec using a multi-layered structure;

FIG. 2 is a schematic diagram showing three conventional prediction methods;

FIG. 3 is a schematic diagram showing the basic concept of Virtual Base-layer Prediction (VBP) according to the present invention;

FIG. 4 is a diagram showing an example of the implementation of VBP using forward inter-prediction of a base layer;

FIG. 5 is a diagram showing an example of the implementation of VBP using backward inter-prediction of a base layer;

FIG. 6A is a diagram showing an example of partitions constituting a frame to be inter-predicted;

FIG. 6B is a diagram showing an example of partitions having a hierarchical variable size based on H.264;

FIG. 6C is a diagram showing an example of partitions constituting a macroblock and motion vectors for respective partitions;

FIG. 6D is a diagram showing a motion vector for a specific partition;

FIG. 6E is a diagram showing a process of configuring a motion compensated frame;

FIG. 6F is a diagram showing a process of generating a virtual base layer frame according to a first exemplary embodiment of the present invention;

FIG. 6G is a diagram showing various pixel areas in a virtual base layer frame generated according to the first exemplary embodiment of the present invention;

FIGS. 7A and 7B are diagrams showing a process of generating a virtual base layer frame according to a second exemplary embodiment of the present invention;

FIG. 8 is a block diagram showing the construction of a video encoder according to an exemplary embodiment of the present invention;

FIG. 9 is a block diagram showing the construction of a video decoder according to an exemplary embodiment of the present invention;

FIG. 10 is a diagram showing the construction of a system environment in which the video encoder and the video decoder are operated;

FIG. 11 is a flowchart showing a video encoding process according to an exemplary embodiment of the present invention; and

FIG. 12 is a flowchart showing a video decoding process according to an exemplary embodiment of the present invention.

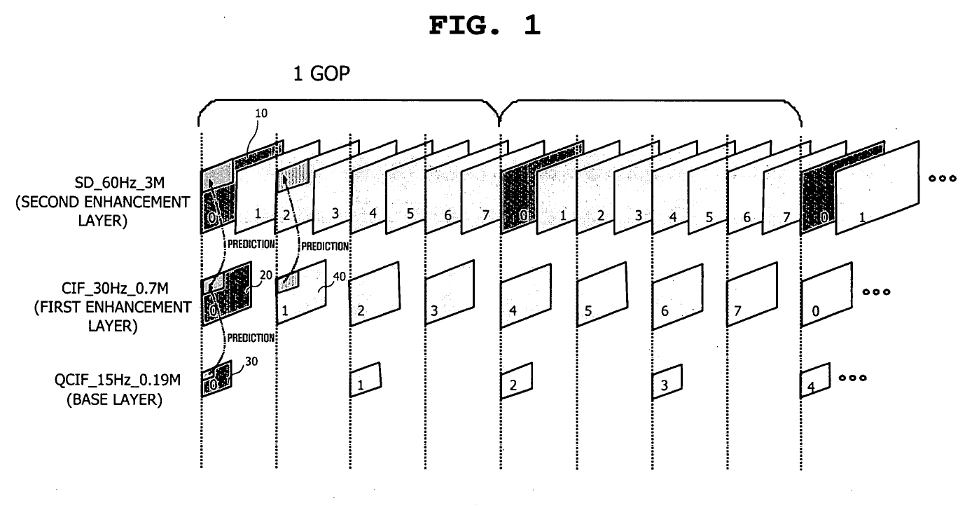

### DETAILED DESCRIPTION OF THE EXEMPLARY EMBODIMENTS

Hereinafter, exemplary embodiments of the present invention will be described in detail with reference to the attached drawings. The features and advantages of the present invention will be more clearly understood from the exemplary embodiments, which will be described in detail in conjunction with the accompanying drawings. However, the present invention is not limited to the disclosed exemplary embodiments, but can be implemented in various forms. The exemplary embodiments are provided to complete the disclosure of the present invention, and sufficiently notify those skilled in the art of the scope of the present invention. The present invention is defined by the attached claims. The same reference numerals are used throughout the different drawings to designate the same or similar components.

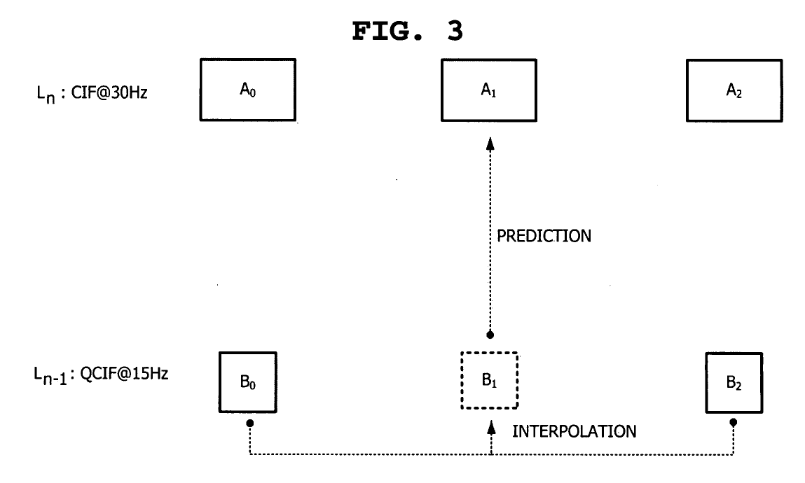

FIG. 3 is a schematic diagram showing the basic concept of Virtual Base-layer Prediction (VBP) according to the present invention. In this case, it is assumed that a current layer Lₙ has a resolution of CIF and a frame rate of 30 Hz, and a lower layer Lₙ₋₁ has a resolution of QCIF and a frame rate of 15 Hz. In the present specification, a current layer frame having no corresponding base layer frame is defined as an “unsynchronized frame”, and a current layer frame having a corresponding base layer frame is defined as a “synchronized frame”. Since an unsynchronized frame does not have a base layer frame, the present invention proposes a method of generating a virtual base layer frame and utilizing the virtual base layer frame for Intra-BL prediction.

As shown in FIG. 3, when the frame rates of a current layer and a lower layer are different, a lower layer frame corresponding to an unsynchronized frame A₁ does not exist, so that a virtual base layer frame B₁ can be interpolated using the two lower layer frames B₀ and B₂ closest to the unsynchronized frame A₁. Further, the unsynchronized frame A₁ can be efficiently predicted using the interpolated virtual base layer frame B₁. In the present specification, a method of predicting an unsynchronized frame using a virtual base layer frame is defined as virtual base-layer prediction (hereinafter referred to as “VBP”).

As described above, the concept of VBP according to the present invention can be applied to two layers having different frame rates. Therefore, VBP can also be applied to the case in which a current layer and a lower layer use a hierarchical inter-prediction method, such as Motion Compensated Temporal Filtering (MCTF), as well as the case in which a current layer and a lower layer use a non-hierarchical inter-prediction method (I-B-P coding of an MPEG system codec). Therefore, when a current layer uses MCTF, the concept of VBP can be applied to the temporal level of the MCTF having a frame rate higher than that of a lower layer.

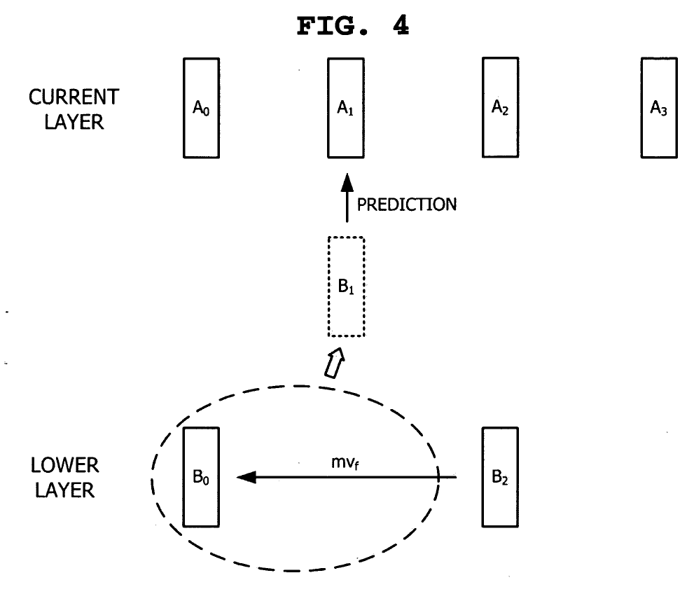

FIGS. 4 and 5 are diagrams showing examples of a method of implementing VBP according to the present invention. In the examples, a virtual base layer frame B₁ is generated using a motion vector between two frames B₀ and B₂ closest to an unsynchronized frame A₁ in a lower layer, and a reference of the frames B₀ and B₂.

FIG. 4 illustrates an example of implementing VBP using forward inter-prediction of a lower layer. Referring to FIG. 4, the frame B₂ of a base layer is predicted through forward inter-prediction by using its previous frame B₀ as a reference frame. That is, after a forward motion vector mv_{f} is obtained by using the previous frame B₀ as a reference frame Fᵣ, the reference frame is motion-compensated using the obtained motion vector, and the frame B₂ is inter-predicted using the motion-compensated reference frame.

In the exemplary embodiment of FIG. 4, the virtual base layer frame B₁ is generated using the forward motion vector mv_{f}, which is used for inter-prediction in the base layer, and the frame B₀, which is used as the reference frame Fr.

Meanwhile, FIG. 5 illustrates an example of implementing VBP using backward inter-prediction of a base layer. Referring to FIG. 5, the frame B₀ of a base layer is predicted through backward inter-prediction by using the subsequent frame B₂ as a reference frame. That is, after a backward motion vector mv_{b} is obtained by using the subsequent frame B₂ as a reference frame Fᵣ, the reference frame is motion-compensated using the obtained motion vector, and the frame B₀ is inter-predicted using the motion-compensated reference frame.

In the exemplary embodiment of FIG. 5, the virtual base layer frame B₁ is generated using the backward motion vector mv_{b}, which is used for inter prediction in the base layer, and the frame B₂, which is used as the reference frame Fᵣ.

In the present specification, by way of additional description for clarification, an inter-prediction method referring to a temporally previous frame is designated forward prediction, and an inter-prediction method referring to a temporally subsequent frame is designated backward prediction.

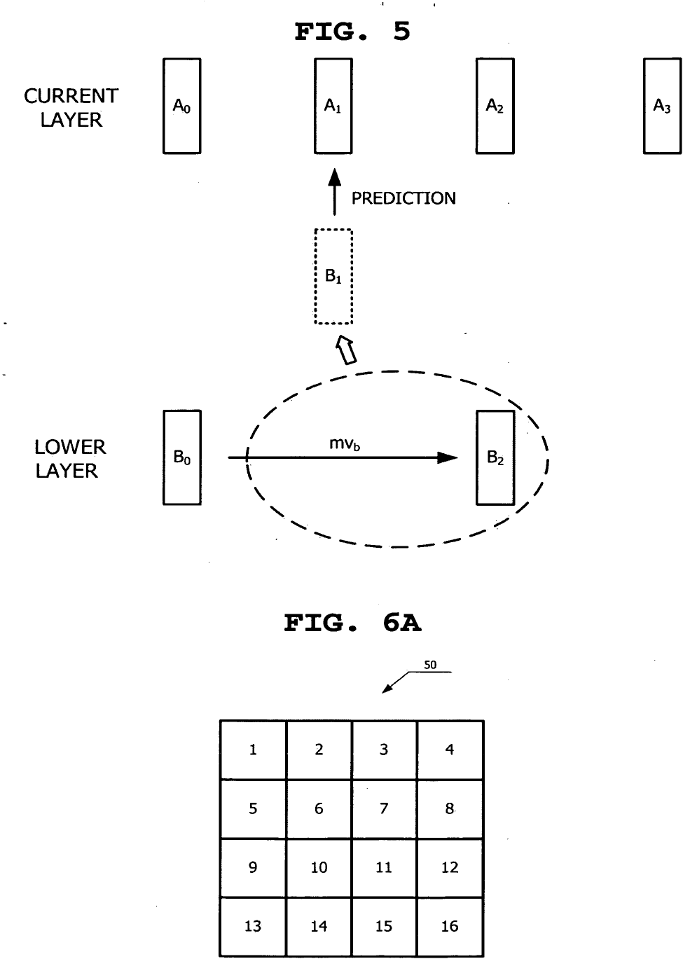

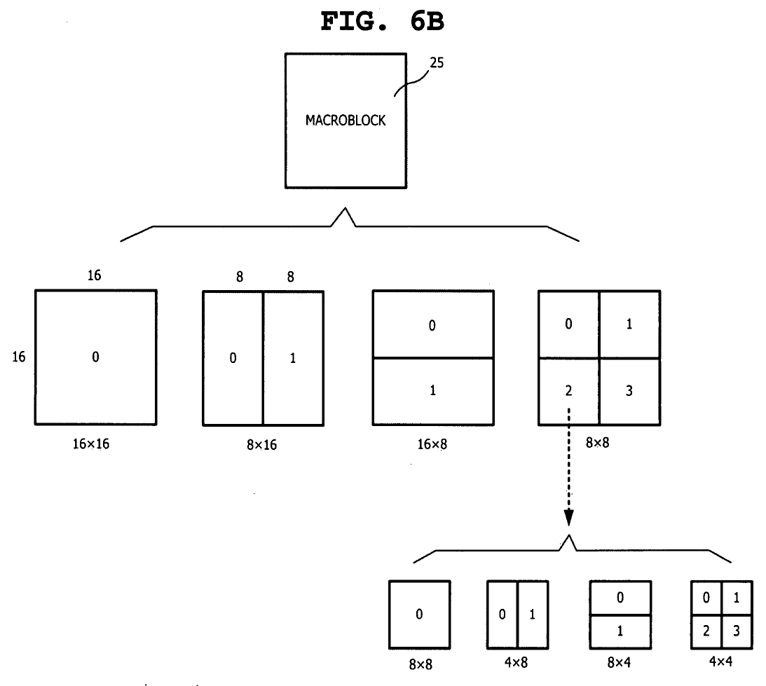

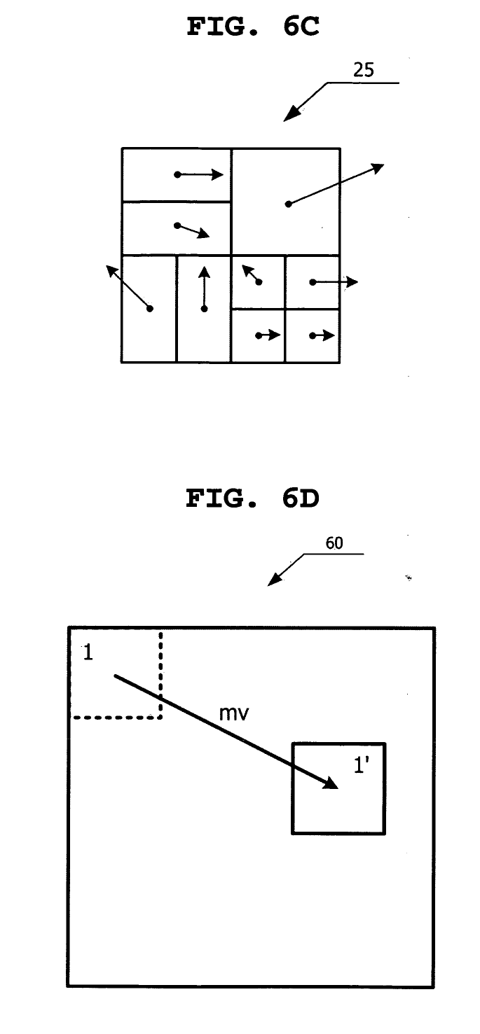

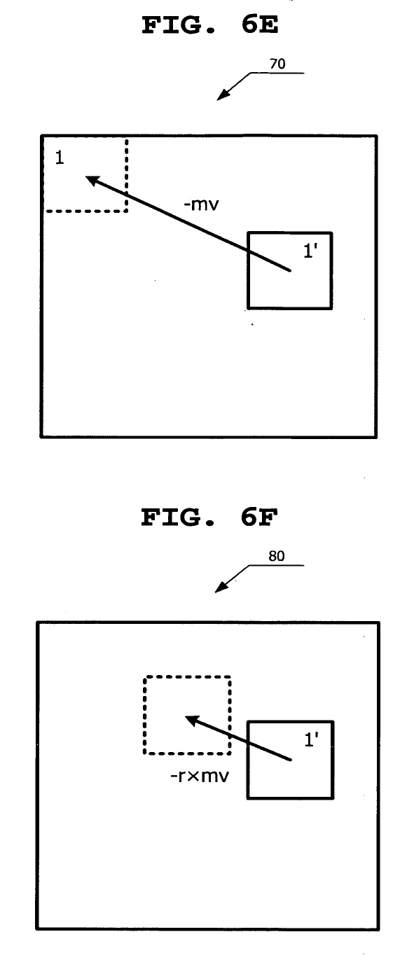

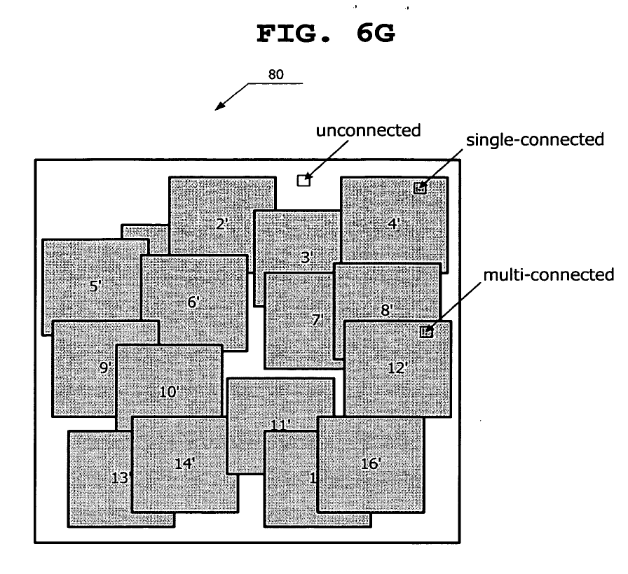

FIGS. 6A to 6G are diagrams showing the concept of generation of a virtual base layer frame according to a first exemplary embodiment of the present invention.

First, it is assumed that, of two base layer frames closest to an unsynchronized frame, one frame 50 to be inter-predicted is composed of a plurality of partitions, as shown in FIG. 6A. In the case of forward prediction, the frame 50 may be B₂ of FIG. 4, while in the case of backward prediction, the frame 50 may be B₀ of FIG. 5. In the present specification, each “partition” means a unit area used for motion estimation, that is, for searching for a motion vector. The partition may have a fixed size (for example, 4×4, 8×8, or 16×16), as shown in FIG. 6A, or may have a variable size, as in the case of the H.264 codec.

The existing H.264 codec utilizes Hierarchical Variable Size Block Matching (HVSBM) technology to perform inter-prediction on each macroblock (having a 16×16 size) constituting a single frame, as shown in FIG. 6B. A single macroblock 25 can be divided into sub-blocks having four modes. That is, the macroblock 25 can be divided once into sub-blocks in 16×16 mode, 8×16 mode, 16×8 mode and 8×8 mode. Each of the sub-blocks having an 8×8 size can be further sub-divided into sub-blocks in 4×8 mode, 8×4 mode and 4×4 mode (if it is not sub-divided, the 8×8 mode is used without change).

The selection of a combination of optimal sub-blocks constituting the single macroblock 25 can be performed by selecting a case having a minimum cost among various combinations. As the macroblock 25 is further sub-divided, precise block matching can be realized, while the amount of motion data (motion vectors, sub-block modes, and others) increases in proportion to the number of sub-divisions. Therefore, an optimal point can be detected between blocking matching and the amount of motion data.

If such hierarchical variable size blocking matching technology is used, one frame is implemented with a set of macroblocks 25 each having the above-described various combinations of partitions, and each partition has a single motion vector. An example of the shape of a partition (indicated by a rectangle), determined by hierarchical variable size block matching in the single macroblock 25, and motion vectors for respective partitions (indicated by arrows) is shown in FIG. 6C.

As described above, a “partition” in the present invention means a unit of area to which a motion vector is assigned. It should be apparent that the size and shape of a partition can vary according to the type of codec. However, for convenience of description, the frame 50 to be inter-predicted is assumed to have fixed-size partitions, as shown in FIG. 6A. Further, in the present specification, reference numeral 50 denotes the frame of a lower layer (for example, B₂ of FIG. 4, and B₀ of FIG. 5), and reference numeral 60 denotes a reference frame (for example, B₀ of FIG. 4 and B₂ of FIG. 5) used for inter-prediction.

If the motion vector mv of a partition 1 in the frame 50 is determined as shown in FIG. 6D, an area in the reference frame 60 corresponding to the partition 1 is an area 1′ at a location that is moved away from the location of the partition 1 by the motion vector. In this case, a motion compensated frame 70 for the reference frame is generated by duplicating texture data of the area 1′ in the reference frame 60 to the location of the partition 1, as shown in FIG. 6E. When this process is executed with respect to the remaining partitions 2 to 16 in the same manner and all areas are filled with texture data, the motion compensated frame 70 is completed.

In the first exemplary embodiment of the present invention, a virtual base layer frame 80 is generated in consideration of the principles of generating the motion compensated frame, as shown in FIG. 6F. That is, since a motion vector represents a direction in which a certain object moves in a frame, motion compensation is performed to an extent corresponding to a value obtained by multiplying the motion vector by the ratio of the distance between the reference frame 60 and the location at which the virtual base layer frame 80 is to be generated, to the distance between the reference frame 60 and the frame 50 to be inter-predicted (hereinafter referred to as a “distance ratio”, 0.5 in FIGS. 4 and 5). In other words, the virtual base layer frame 80 is filled with texture data in such a way that the area 1′ is copied to a location away from the area 1′ by −r×mv, where r is the distance ratio and mv is the motion vector. When this process is executed with respect to the remaining partitions 2 to 16 in the same manner, and all areas are filled with texture data, the virtual base layer frame 80 is completed.

The first exemplary embodiment is based on a basic assumption that a motion vector represents the movement of a certain object in a frame, and the movement may be generally continuous in a short time unit, such as a frame interval. However, the virtual base layer frame 80 generated according to the method of the first exemplary embodiment may include, for example, an unconnected pixel area and a multi-connected pixel area, as shown in FIG. 6G. In FIG. 6G, since a single-connected pixel area includes only one piece of texture data, there is no problem. However, a method of processing pixel areas other than the single-connected pixel area may be an issue.

As an example, a multi-connected pixel may be replaced with a value obtained by averaging a plurality of pieces of texture data at the corresponding location. Further, an unconnected pixel may be replaced with a corresponding pixel value in the frame 50 to be inter-predicted, with a corresponding pixel value in the reference frame 60, or with a value obtained by averaging corresponding pixel values in the frames 50 and 60.

It is difficult to expect high performance when an unconnected pixel area or a multi-connected pixel area is used for Intra-BL prediction for an unsynchronized frame, compared to the single-connected pixel area. However, there is a high probability that inter-prediction or directional intra-prediction for an unsynchronized frame, rather than Intra-BL prediction, will be selected as a prediction method for the above areas from the standpoint of costs, so that it can be predicted that a deterioration of performance will not occur. Further, in the single-connected pixel area, Intra-BL prediction will exhibit sufficiently high performance. Accordingly, if the pixel areas are determined to be a single frame unit, an enhancement of performance can be expected when the first exemplary embodiment is applied.

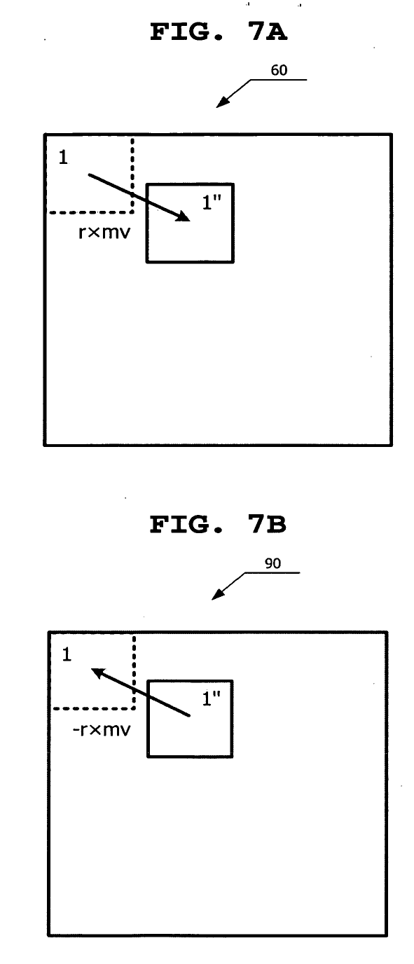

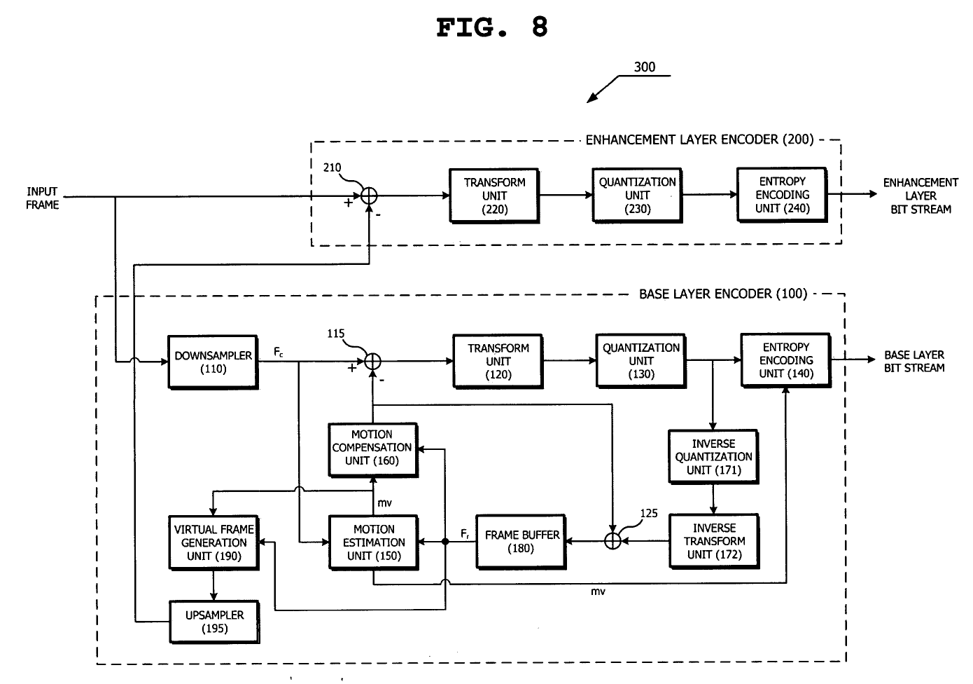

Meanwhile, FIGS. 7A and 7B are diagrams showing the concept of generation of a virtual base layer frame according to another exemplary embodiment (a second exemplary embodiment) of the present invention. The second exemplary embodiment is proposed to solve the problem whereby an unconnected pixel area and a multi-connected pixel area exist in the virtual base layer frame 80 generated in the first exemplary embodiment. The pattern of partitions of a virtual base layer frame 90 in the second exemplary embodiment uses the pattern of partitions of the base layer frame 50 to be inter-predicted without change.

Also in the second exemplary embodiment, description is made with the assumption that the base layer frame 50 to be inter-predicted is as shown in FIG. 6A and a motion vector for a specific partition 1 is as shown in FIG. 6D. In the second exemplary embodiment, as shown in FIG. 7A, an area in a reference frame 60 corresponding to the partition 1 is an area 1″ at a location that is moved from the location of the partition 1 by r×mv. In this case, the virtual base layer frame 90 is generated in such a way that texture data of the area 1″ in the reference frame 60 is copied to the location of the partition 1, as shown in FIG. 7B. When this process is executed with respect to the remaining partitions 2 to 16 in the same manner and all areas are filled with texture data, the virtual base layer frame 90 is completed. Since the virtual base layer frame 90 generated in this way has the same partition pattern as the base layer frame 50 to be inter-predicted, the virtual base layer frame 90 includes only single-connected pixel areas without including unconnected pixel areas or multi-connected pixel areas.

The first and second exemplary embodiments can be independently implemented, but one exemplary embodiment, which combines the exemplary embodiments, can also be considered. That is, the unconnected pixel area of the virtual base layer frame 80 in the first exemplary embodiment is replaced with the corresponding area of the virtual base layer frame 90 obtained in the second exemplary embodiment. Further, the unconnected pixel area and the multi-connected pixel area of the virtual base layer frame 80 in the first exemplary embodiment may be replaced with the corresponding areas of the virtual base layer frame 90 obtained in the second exemplary embodiment.

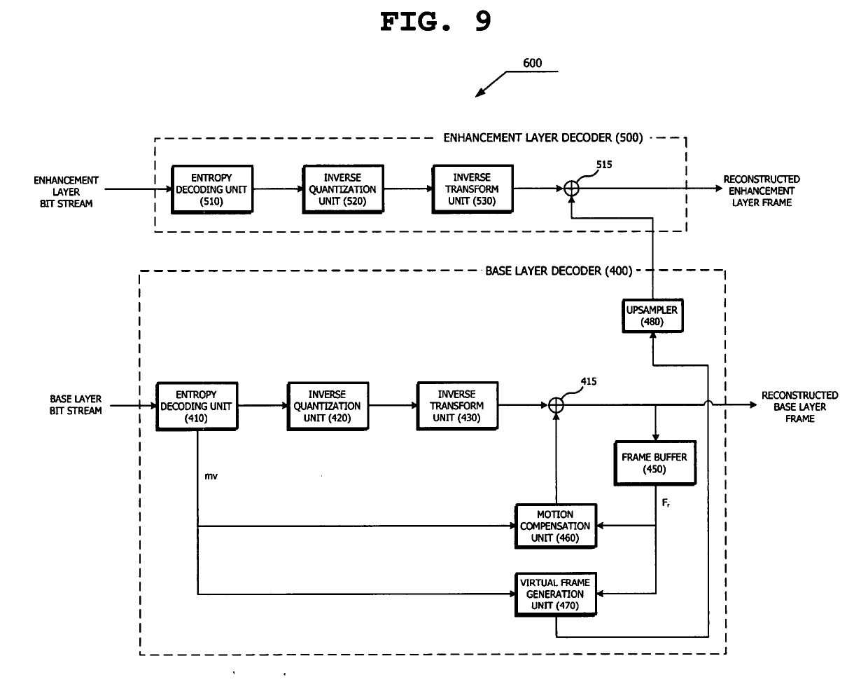

FIG. 8 is a block diagram showing the construction of a video encoder 300 according to an exemplary embodiment of the present invention. In FIG. 8 and FIG. 9, which will be described later, an example in which a single base layer and a single enhancement layer are used is described, but those skilled in the art will appreciate that the present invention can be applied to a lower layer and a current layer even though the number of layers used increases.

The video encoder 300 can be divided into an enhancement layer encoder 200 and a base layer encoder 100. First, the construction of the base layer encoder 100 is described.

A downsampler 110 downsamples input video at a resolution and a frame rate appropriate to a base layer. From the standpoint of resolution, downsampling can be performed using an MPEG downsampler or a wavelet downsampler. Further, from the standpoint of frame rate, downsampling can be easily performed using a frame skip method, a frame interpolation method, and others.

A motion estimation unit 150 performs motion estimation on a base layer frame, and obtains a motion vector mv with respect to each partition constituting the base layer frame. Such motion estimation denotes a procedure of finding an area most similar to each partition of a current frame F_{c} in a reference frame Fᵣ, that is, an area having a minimum error, and can be performed using various methods, such as a fixed size block matching method or a hierarchical variable size block matching method. The reference frame Fᵣ can be provided by a frame buffer 180. The base layer encoder 100 of FIG. 8 adopts a scheme in which a reconstructed frame is used as a reference frame, that is, a closed loop encoding scheme. However, the encoding scheme is not limited to the closed loop encoding method, and the base layer encoder 100 can adopt an open loop encoding scheme in which an original base layer frame, provided by the downsampler 10, is used as a reference frame.

A motion compensation unit 160 performs motion compensation on the reference frame using the obtained motion vector. Further, a subtractor 115 obtains the difference between the current frame F_{c} of the base layer and the motion compensated reference frame, thus generating a residual frame.

A transform unit 120 performs a spatial transform on the generated residual frame and generates a transform coefficient. For the spatial transform method, a Discrete Cosine Transform (DCT), or a wavelet transform are mainly used. When the DCT is used, the transform coefficient denotes a DCT coefficient, and when a wavelet transform is used the transform coefficient denotes a wavelet coefficient.

A quantization unit 130 quantizes the transform coefficient generated by the transform unit 120. Quantization is an operation of dividing the DCT coefficient, expressed as an arbitrary real number, into predetermined intervals based on a quantization table representing the intervals as discrete values, and matching the discrete values to corresponding indices. A quantization result value obtained in this way is called a quantized coefficient.

An entropy encoding unit 140 performs non-lossy encoding on the quantized coefficient, generated by the quantization unit 130, and the motion vector, generated by the motion estimation unit 150, thus generating a base layer bit stream. For the non-lossy encoding method, various non-lossy encoding methods, such as Huffman coding, arithmetic coding or variable length coding can be used.

Meanwhile, an inverse quantization unit 171 performs inverse quantization on the quantized coefficient output from the quantization unit 130. Such an inverse quantization process corresponds to the inverse of the quantization process, and is a process of reconstructing values matching indices, which are generated during the quantization process, from the indices through the use of the quantization table used in the quantization process.

An inverse transform unit 172 performs an inverse spatial transform on an inverse quantization result value. This inverse spatial transform is the inverse to the transform process executed by the transform unit 120. In detail, an inverse DCT, an inverse wavelet transform, and others can be used.

An adder 125 adds the output value of the motion compensation unit 160 to the output value of the inverse transform unit 172, reconstructs the current frame, and provides the reconstructed current frame to the frame buffer 180. The frame buffer 180 temporarily stores the reconstructed frame and provides the reconstructed frame as a reference frame to perform the inter-prediction on another base layer frame.

Meanwhile, a virtual frame generation unit 190 generates a virtual base layer frame to perform Intra-BL prediction on an unsynchronized frame of an enhancement layer. That is, the virtual frame generation unit 190 generates the virtual base layer frame using a motion vector, generated between the two base layer frames temporally closest to the unsynchronized frame, and the reference frame of the two frames. For this operation, the virtual frame generation unit 190 receives the motion vector mv from the motion estimation unit 150, and the reference frame Fr from the frame buffer 180. The detailed procedure of generating the virtual base layer frame using the motion vector and the reference frame has been described with reference to FIGS. 4 to 7B, and therefore detailed descriptions thereof are omitted.

The virtual base layer frame generated by the virtual frame generation unit 190 is selectively provided to the enhancement layer encoder 200 through an upsampler 195. Therefore, the upsampler 195 upsamples the virtual base layer frame at the resolution of the enhancement layer when the resolutions of the enhancement layer and the base layer are different. Of course, when the resolutions of the base layer and the enhancement layer are the same, the upsampling process is omitted.

Next, the construction of the enhancement layer encoder 200 is described.

If an input frame is an unsynchronized frame, the input frame and the virtual base layer frame, provided by the base layer encoder 100, are input to a subtractor 210. The subtractor 210 subtracts the virtual base layer frame from the input frame and generates a residual frame. The residual frame is converted into an enhancement layer bit stream through a transform unit 220, a quantization unit 230, and an entropy encoding unit 240, and the enhancement layer bit stream is output. The functions and operations of the transform unit 220, the quantization unit 230 and the entropy encoding unit 240 are similar to those of the transform unit 120, the quantization unit 130 and the entropy encoding unit 140, and therefore detailed descriptions thereof are omitted.

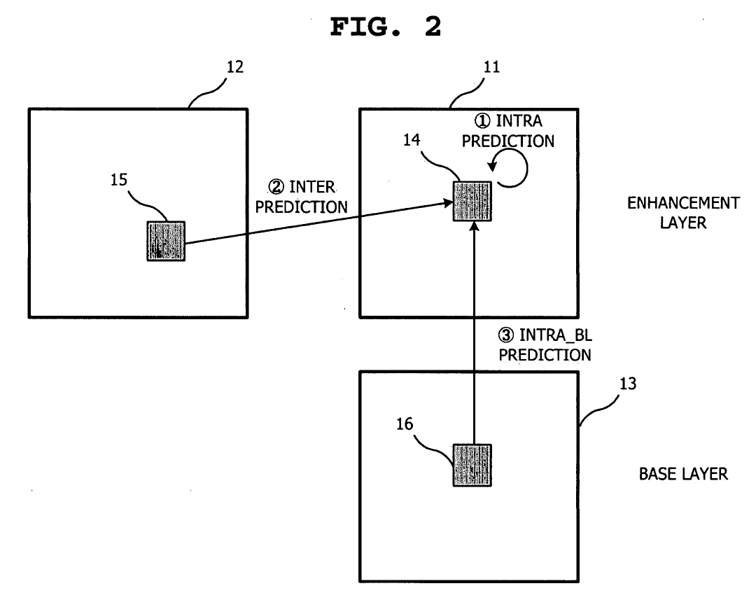

The enhancement layer encoder 200 of FIG. 8 is described with respect to the encoding of an unsynchronized frame among input frames. Of course, those skilled in the art will appreciate that if the input frame is a synchronized frame, three conventional prediction methods can be selectively used to perform encoding, as described above with reference to FIG. 2.

FIG. 9 is a block diagram showing the construction of a video decoder 600 according to an exemplary embodiment of the present invention. The video decoder 600 can be divided into an enhancement layer decoder 500 and a base layer decoder 400. First, the construction of the base layer decoder 400 is described.

An entropy decoding unit 410 performs non-lossy decoding on a base layer bit stream, thus extracting texture data of a base layer frame and motion data (a motion vector, partition information, a reference frame number, and others).

An inverse quantization unit 420 performs inverse quantization on the texture data. This inverse quantization process corresponds to the inverse of the quantization process executed by the video encoder 300, and is a process of reconstructing values matching indices, which are generated during the quantization process, from the indices through the use of the quantization table used in the quantization process.

An inverse transform unit 430 performs an inverse spatial transform on the inverse quantization result, thus reconstructing a residual frame. This inverse spatial transform is the inverse of the transform process executed by the transform unit 120 of the video encoder 300. In detail, the inverse DCT, inverse wavelet transform, or others can be used as the inverse transform.

Meanwhile, an entropy decoding unit 410 provides motion data, including a motion vector mv, to both a motion compensation unit 460 and a virtual frame generation unit 470.

The motion compensation unit 460 performs motion compensation on a previously reconstructed video frame provided by a frame buffer 450, that is, a reference frame, using the motion data provided by the entropy decoding unit 410, thus generating a motion compensated frame. Of course, such a motion compensation procedure is applied only when a current frame is encoded through inter-prediction by the encoder.

An adder 415 adds a residual frame reconstructed by the inverse transform unit 430 to the motion compensated frame generated by the motion compensation unit 460, thus reconstructing a base layer video frame. The reconstructed video frame can be temporarily stored in the frame buffer 450, and can be provided to the motion compensation unit 460 or the virtual frame generation unit 470 as a reference frame so as to reconstruct other subsequent frames.

Meanwhile, the virtual frame generation unit 470 generates a virtual base layer frame to perform Intra-BL prediction on an unsynchronized frame of an enhancement layer. That is, the virtual frame generation unit 470 generates the virtual base layer frame using a motion vector generated between the two base layer frames temporally closest to the unsynchronized frame and the reference frame of the two frames. For this operation, the virtual frame generation unit 470 receives the motion vector mv from the entropy decoding unit 410 and the reference frame Fᵣ from the frame buffer 450. The detailed procedure of generating the virtual base layer frame using the motion vector and the reference frame has been described with reference to FIGS. 4 to 7B, and therefore detailed descriptions thereof are omitted.

The virtual base layer frame generated by the virtual frame generation unit 470 is selectively provided to the enhancement layer decoder 500 through an upsampler 480. Therefore, the upsampler 480 upsamples the virtual base layer frame at the resolution of the enhancement layer when the resolutions of the enhancement layer and the base layer are different. Of course, when the resolutions of the base layer and the enhancement layer are the same, the upsampling process is omitted.

Next, the construction of the enhancement layer decoder 500 is described. If part of an enhancement layer bit stream related to an unsynchronized frame is input to an entropy decoding unit 510, the entropy decoding unit 510 performs non-lossy decoding on the input bit stream and extracts the texture data of the unsynchronized frame.

Further, the extracted texture data is reconstructed as a residual frame through an inverse quantization unit 520 and an inverse transform unit 530. The function and operation of the inverse quantization unit 520 and the inverse transform unit 530 are similar to those of the inverse quantization unit 420 and the inverse transform unit 430.

An adder 515 adds the reconstructed residual frame to the virtual base layer frame provided by the base layer decoder 400, thus reconstructing the unsynchronized frame.

In the previous description, the enhancement layer decoder 500 of FIG. 9 has been described based on the decoding of an unsynchronized frame among input frames. Of course, those skilled in the art will appreciate that if an enhancement layer bit stream is related to a synchronized frame, reconstruction methods according to three conventional prediction methods can be selectively used, as described above with reference to FIG. 2.

FIG. 10 is a diagram showing the construction of a system environment, in which the video encoder 300 or video decoder 600 operates, according to an exemplary embodiment of the present invention. Such a system may be a TV, set-top box, a desk-top computer, a lap-top computer, a handheld computer, a Personal Digital Assistant (PDA), or video or image storage device, for example, a Video Cassette Recorder (VCR] or a Digital Video Recorder (DVR). Moreover, the system may be a combination of the devices, or a specific device including another device. The system may include at least one video source 910, at least one input/output device 920, a processor 940, memory 950, and a display device 930.

The video source 910 may be a TV receiver, a VCR, or another video storage device. Further, the video source 910 may include a connection to one or more networks for receiving video from a server using the Internet, a Wide Area Network (WAN), a Local Area Network (LAN), a terrestrial broadcast system, a cable network, a satellite communication network, a wireless network, or a telephone network. Moreover, the video source may be a combination of the networks, or a specific network including another network as a part of the specific network.

The input/output device 920, the processor 940, and the memory 950 communicate with each other through a communication medium 960. The communication medium 960 may be a communication bus, a communication network, or one or more internal connection circuits. The input video data received from the source 910 may be processed by the processor 940 using one or more software programs stored in the memory 950, or it may be executed by the processor 940 to generate video to be output to the display device 930.

In particular, the software program stored in the memory 950 may include a multi-layered video codec for performing the method of the present invention. The codec may be stored in the memory 950, be read from a storage medium, such as Compact Disc-Read Only Memory (CD-ROM) or a floppy disc, or be downloaded from a server through various networks. The codec may be implemented as a hardware circuit or as a combination of hardware circuits and software.

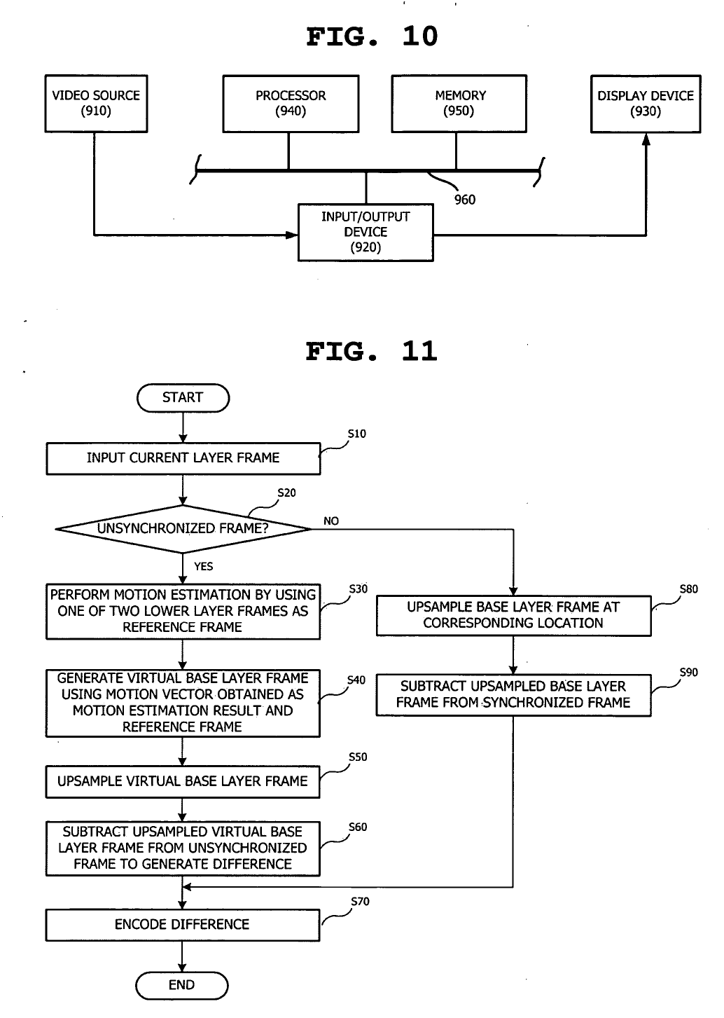

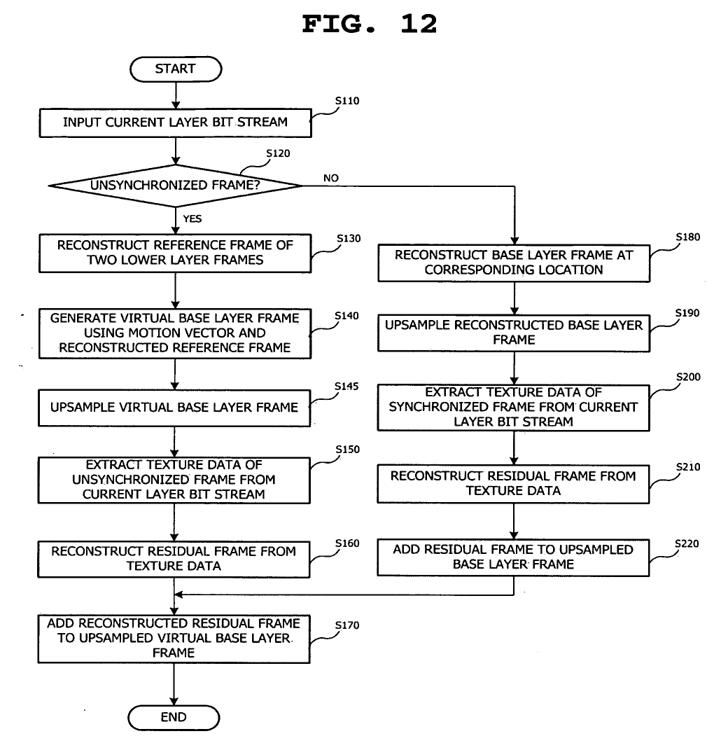

FIG. 11 is a flowchart showing a video encoding process according to an exemplary embodiment of the present invention.

First, if the frame of a current layer is input to the enhancement layer encoder 200 in operation S10, whether the frame is an unsynchronized frame or a synchronized frame is determined in operation S20.

As a result of the determination, if the frame is an unsynchronized frame (the case of “yes” in operation S20), the motion estimation unit 150 performs motion estimation by using one of two lower layer frames, temporally closest to the unsynchronized frame of the current layer, as a reference frame in operation S30. The motion estimation can be performed using fixed size blocks or hierarchical variable size blocks. The reference frame may be a temporally previous frame of the two lower layer frames, as shown in FIG. 4, or a temporally subsequent frame, as shown in FIG. 5.

Then, the virtual frame generation unit 190 generates a virtual base layer frame at the same temporal location as the unsynchronized frame using the motion vector obtained as a result of motion estimation, and the reference frame in operation S40.

According to a first exemplary embodiment of the present invention, operation S40 includes the operation of reading texture data of an area spaced apart from the location of a partition, to which the motion vector is assigned, by the motion vector, from the reference frame, and the operation of copying the read texture data to a location away, in a direction opposite the motion vector, from the area by a value obtained by multiplying the motion vector by the distance ratio. In this case, as a result of the copying, an unconnected pixel area may be replaced with texture data of an area of the reference frame corresponding to the unconnected pixel area. As a result of the copying, a multi-connected pixel is replaced with a value obtained by averaging texture data copied from the corresponding location.

Meanwhile, according to a second exemplary embodiment of the present invention, operation S40 includes the operation of reading texture data of an area spaced apart from the location of the partition, to which the motion vector is assigned, by a value obtained by multiplying the motion vector by the distance ratio, from the reference frame and the operation of copying the read texture data to the location of the partition.

When the resolutions of the current layer and the lower layer are different, the upsampler 195 upsamples the generated virtual base layer frame at the resolution of the current layer in operation S50.

Then, the subtractor 210 of the enhancement layer encoder 200 subtracts the upsampled virtual base layer frame from the unsynchronized frame to generate a difference in operation S60. Further, the transform unit 220, the quantization unit 230 and the entropy encoding unit 240 encode the difference in operation S70.

Meanwhile, if the frame is a synchronized frame (the case of “no” in operation S20), the upsampler 190 upsamples a base layer frame at a location corresponding to the current synchronized frame at the resolution of the current layer in operation S80. The subtractor 210 subtracts the upsampled base layer frame from the synchronized frame to generate a difference in operation S90. The difference is also encoded through the transform unit 220, the quantization unit 230 and the entropy encoding unit 240 in operation S70.

FIG. 12 is a flowchart showing a video decoding process according to an exemplary embodiment of the present invention.

If the bit stream of a current layer is input in operation S110, whether the current layer bit stream is related to an unsynchronized frame is determined in operation S120.

As a result of the determination, if the current layer bit stream is related to an unsynchronized frame (the case of “yes” in operation S120), the base layer decoder 400 reconstructs a reference frame of two lower layer frames temporally closest to the unsynchronized frame of the current layer from a lower layer bit stream in operation S130.

Then, the virtual frame generation unit 470 generates a virtual base layer frame at the same temporal location as the unsynchronized frame using the motion vector included in the lower layer bit stream and the reconstructed reference frame in operation S140. Of course, the first and second exemplary embodiments can be applied to operation S140, similar to the video encoding process. When the resolutions of the current layer and the lower layer are different, the upsampler 480 upsamples the generated virtual base layer frame at the resolution of the current layer in operation S145.

Meanwhile, the entropy decoding unit 510 of the enhancement layer decoder 500 extracts the texture data of the unsynchronized frame from a current layer bit stream in operation S150. The inverse quantization unit 520 and the inverse transform unit 530 reconstruct a residual frame from the texture data in operation S160. Then, the adder 515 adds the residual frame to the virtual base layer frame in operation S170. As a result, the unsynchronized frame is reconstructed.

If the frame is related to a synchronized frame, in operation S120 (the case of “no” in operation S120), the base layer decoder 400 reconstructs a base layer frame at a location corresponding to the synchronized frame in operation S180. Further, the upsampler 480 upsamples the reconstructed base layer frame in operation S190. Meanwhile, the entropy decoding unit 510 extracts the texture data of the synchronized frame from the current layer bit stream in operation S200. The inverse quantization unit 520 and the inverse transform unit 530 reconstruct a residual frame from the texture data in operation S210. Then, the adder 515 adds the residual frame to the upsampled base layer frame in operation S220. As a result, the synchronized frame is reconstructed.

Although the exemplary embodiments of the present invention have been disclosed for illustrative purposes, those skilled in the art will appreciate that the present invention can be implemented in other detailed forms without changing the technical spirit or essential features of the invention. Therefore, it should be understood that the above embodiments are only exemplary in all aspects and are not restrictive.

According to the present invention, there is an advantage in that Intra-BL prediction can be performed with respect to an unsynchronized frame using a virtual base layer frame.

Further, according to the present invention, there is an advantage in that video compression efficiency can be improved by a more efficient prediction method.

What is claimed is:

1. A multi-layered video encoding method comprising:
performing motion estimation by using one of two frames of a lower layer temporally closest to an unsynchronized frame of a current layer as a reference frame;
generating a virtual base layer frame at a same temporal location as that of the unsynchronized frame using a motion vector obtained as a result of the performing the motion estimation and the reference frame;
subtracting the virtual base layer frame from the unsynchronized frame to generate a difference; and
encoding the difference.

2. The multi-layered video encoding method according to claim 1, further comprising upsampling the virtual base layer frame at the resolution of the current layer if resolutions of the current layer and the lower layer are different,
wherein the subtracting the virtual base layer frame from the unsynchronized frame comprises subtracting the upsampled virtual base layer frame from the unsynchronized frame to generate the difference.

3. The multi-layered video encoding method according to claim 1, wherein the reference frame is a temporally previous frame of the lower layer frames.

4. The multi-layered video encoding method according to claim 1, wherein the reference frame is a temporally subsequent frame of the lower layer frames.

5. The multi-layered video encoding method according to claim 1, wherein the motion estimation is performed by hierarchical variable size blocking matching.

6. The multi-layered video encoding method according to claim 1, wherein the generating the virtual base layer frame comprises:
reading texture data from the reference frame of an area spaced apart from a location of a partition, to which the motion vector is assigned, by the motion vector; and
copying the texture data to a location that is away, in a direction opposite the motion vector, from the area by a value obtained by multiplying the motion vector by a distance ratio.

7. The multi-layered video encoding method according to claim 6, wherein the generating the virtual base layer frame further comprises replacing an unconnected pixel area, obtained as a result of the copying, with texture data of an area of the reference frame corresponding to the unconnected pixel area.

8. The multi-layered video encoding method according to claim 7, wherein the generating the virtual base layer frame further comprises replacing a multi-connected pixel area, obtained as a result of the copying, with a value obtained by averaging a plurality of pieces of texture data copied to a corresponding location.

9. The multi-layered video encoding method according to claim 1, wherein the generating the virtual base layer frame comprises:
reading from the reference frame texture data of an area spaced from a location of a partition, to which the motion vector is assigned, by a value obtained by multiplying the motion vector by a distance ratio; and
copying the read texture data to the location of the partition.

10. The multi-layered video encoding method according to claim 1, wherein the encoding the difference comprises:
performing a spatial transform on the difference to generate a transform coefficient;
performing quantization on the transform coefficient to generate a quantized coefficient; and
performing non-lossy encoding on the quantized coefficient.

11. A multi-layered video decoding method comprising:
reconstructing a reference frame among two frames of a lower layer temporally closest to an unsynchronized frame of a current layer from a lower layer bit stream;
generating a virtual base layer frame at a same temporal location as the unsynchronized frame using a motion vector included in the lower layer bit stream, and the reference frame;
extracting texture data of the unsynchronized frame from a current layer bit stream, and reconstructing a residual frame from the texture data; and
adding the residual frame to the virtual base layer frame.

12. The multi-layered video decoding method according to claim 11, further comprising upsampling the virtual base layer frame at a resolution of the current layer if resolutions of the current layer and the lower layer are different,
wherein the adding the residual frame to the virtual base layer frame comprises adding the residual frame to the upsampled virtual base layer frame.

13. The multi-layered video decoding method according to claim 11, wherein the reference frame is a temporally previous frame of the lower layer frames.

14. The multi-layered video decoding method according to claim 11, wherein the reference frame is a temporally subsequent frame of the lower layer frames.

15. The multi-layered video decoding method according to claim 11, wherein the generating the virtual base layer frame comprises:
reading from the reference frame texture data of an area spaced apart from a location of a partition, to which the motion vector is assigned, by the motion vector; and
copying the read texture data to a location that is away, in a direction opposite the motion vector, from the area by a value obtained by multiplying the motion vector by a distance ratio.

16. The multi-layered video decoding method according to claim 11, wherein the generating the virtual base layer frame comprises:
reading from the reference frame texture data of an area spaced apart from a location of a partition, to which the motion vector is assigned, by a value obtained by multiplying the motion vector by a distance ratio; and
copying the read texture data to the location of the partition.

17. A multi-layered video encoder comprising:
means for performing motion estimation by using one of two frames of a lower layer temporally closest to an unsynchronized frame of a current layer as a reference frame;
means for generating a virtual base layer frame at a same temporal location as that of the unsynchronized frame using a motion vector obtained as a result of the motion estimation and the reference frame;
means for subtracting the generated virtual base layer frame from the unsynchronized frame to generate a difference; and
means for encoding the difference.

18. A multi-layered video decoder comprising:
means for reconstructing a reference frame of two frames of a lower layer temporally closest to an unsynchronized frame of a current layer from a lower layer bit stream;
means for generating a virtual base layer frame at the same temporal location as the unsynchronized frame using a motion vector included in the lower layer bit stream, and the reconstructed reference frame;
means for extracting texture data of the unsynchronized frame from a current layer bit stream, and reconstructing a residual frame from the texture data; and
means for adding the residual frame to the virtual base layer frame.

19. A recording medium for storing a computer-readable program for performing a multi-layered video encoding method, the method comprising:
performing motion estimation by using one of two frames of a lower layer temporally closest to an unsynchronized frame of a current layer as a reference frame;
generating a virtual base layer frame at a same temporal location as that of the unsynchronized frame using a motion vector obtained as a result of the performing the motion estimation and the reference frame;
subtracting the virtual base layer frame from the unsynchronized frame to generate a difference; and
encoding the difference.

20. A recording medium for storing a computer-readable program for performing a multi-layered video decoding method, the method comprising:
reconstructing a reference frame among two frames of a lower layer temporally closest to an unsynchronized frame of a current layer from a lower layer bit stream;
generating a virtual base layer frame at a same temporal location as the unsynchronized frame using a motion vector included in the lower layer bit stream, and the reference frame;
extracting texture data of the unsynchronized frame from a current layer bit stream, and reconstructing a residual frame from the texture data; and
adding the residual frame to the virtual base layer frame.
